(19) United States
(12) Patent Application Publication
(10) Pub. No.: US 2020/0057955 A1
(43) Pub. Date: Feb. 20, 2020

(54) PREDICTING STATE OF A SYSTEM BASED ON ADVECTION

(71) Applicant: NAVICAN GENOMICS, INC., San Diego, CA (US)

(72) Inventors: David Balaban, San Diego, CA (US); Todd W. Kelley, San Diego, CA (US); John Scott Skellenger, San Diego, CA (US); Mark Durst, San Diego, CA (US); Michael Tupikov, San Diego, CA (US); Nicolas Sean Frisby, San Diego, CA (US); Dominic Joseph Steinitz, San Diego, CA (US)

(21) Appl. No.: 16/297,482

(22) Filed: Mar. 8, 2019

Related U.S. Application Data
(60) Provisional application No. 62/783,127, filed on Dec. 20, 2018.
(60) Provisional application No. 62/739,016, filed on Sep. 28, 2018.
(60) Provisional application No. 62/733,988, filed on Sep. 20, 2018.
(60) Provisional application No. 62/720,084, filed on Aug. 20, 2018.

(51) Int. Cl. G06N 7/00; G06F 11/34; G06F 11/30

(52) U.S. Cl. CPC G06N 7/005; G06F 11/3024; G06F 11/3409

(57) ABSTRACT

A system for modeling the evolution of a system over time using an advection-based process is provided. The system continuously evolves a probability density function (“PDF”) for a characteristic of a characteristic of the state of the system and its time-varying parameters. The PDF is evolved based on advection by solving an advection partial differential equation that is based on a system model of the system. The system model has time-varying parameters for modeling the characteristic of the state of the system. The system uses the continuously evolving PDF to make predictions out the characteristic of the state of the system.

### CROSS REFERENCE TO RELATED APPLICATIONS

This application claims the benefit of U.S. Provisional Application No. 62/783,127, filed on Dec. 20, 2018, U.S. Provisional Application No. 62/739,016, filed on Sep. 28, 2018, U.S. Provisional Application No. 62/733,988, filed on Sep. 20, 2018, and, U.S. Provisional Application No. 62/720,084, filed on Aug. 20, 2018, which are all incorporated by reference herein in their entireties.

### BACKGROUND

Current techniques for predicting change in the state of a biological system (e.g., the size of a tumor in a liver) of a patient are in general not particularly accurate. Some current techniques base predictions on data collected from the general population or a certain subset of the population. These current techniques do not effectively factor in the characteristics that are specific to each patient. Those characteristics may include demographics, prior history of treatment (e.g., chemotherapy regimen), current treatment regimen, physiological characteristics, and so on. As a result, these current techniques do not provide predictions that are accurate for some patients and should not be used to inform a treatment regimen for those patients. It is, however, difficult to determine the accuracy of the current techniques (at least not in advance) for each patient.

The behavior of a biological system, however, can be modeled in a way that factors in various characteristics of the patient. For example, given the history of the growth of a patient's tumor, a model for that patient can be generated that could be used to predict the size of the tumor at a future time. As measurements of the state of the biological system are collected over time, a model can input those measurements and be used to predict the state of the biological system at a future time. It would be desirable to have techniques that would make accurate predictions of the state of a biological system. With accurate predictions, a treatment regimen can be developed that results in better patient outcomes and in lower healthcare costs.

### BRIEF DESCRIPTION OF THE DRAWINGS

FIG. 1 is a block diagram that illustrates high-level components of the ABM system in some embodiments.

FIG. 2 includes flow diagrams that illustrate the overall processing of components of the ABM system in some embodiments.

FIG. 3 is a flow diagram of a run simulation component.

FIG. 4 is a flow diagram that illustrates the processing of an initialize simulation component.

FIG. 5 is a flow diagram that illustrates the processing of a perform simulation iteration component.

### DETAILED DESCRIPTION

Methods and systems are provided for modeling the evolution of a biological system overtime using an advection-based process to make predictions about the biological system. In some embodiments, an advection-based modeling (“ABM”) system continuously evolves a probability density function (“PDF”), which is a joint PDF, for a characteristic relating to the physiological state of the biological system and its time-varying parameters. The PDF is evolved based on advection by solving an advection partial differential equation (“PDE”) to learn parameter values for a model of the characteristic of the physiological state of the biological system. The physiological model has time-varying parameters for modeling the characteristic. For example, the biological system may be a liver and the state of the liver may be hepatocyte count. Since it is very difficult for the hepatocyte count to be measured directly (e.g., via a biopsy), the ABM system employs measurements of a characteristic, such as liver enzyme count in the blood, of the state of the liver to model the liver enzyme count from which the state of the liver can be inferred. The ABM system uses the continuously evolving PDF to make predictions about the characteristic of the state of the biological system. For example, a prediction may be the liver enzyme count at a future time.

The predictions of a characteristic of a state can be used to inform treatment for a patient. For example, the liver enzyme count may indicate whether a patient has an undesired level of hepatocytes. The ABM system can be used to predict the liver enzyme count at a prediction time. If the prediction liver enzyme count indicates that the patient will have an undesired level of hepatocytes, the drugs and/or dosing used to treat the patient can be modified to control the level of hepatocytes. For example, a model predictive control system can be used to determine dosing based on the predicted measurement to achieve a desired outcome. (See, e.g., Gaweda, A., Muezzinoglu, M., Jacobs, A., Aronoff, G., and Brier, M., “Model Predictive Control with Reinforcement Learning for Drug Delivery in Renal Anemia Management” Conf. Proc., Annual international Conference of the IEEE Engineering in Medicine and Biology Society IEEE Engineering in Medicine and Biology Society Conference, 2006). Thus, the ABM system can be used as part of a method for treating a patient by predicting the characteristic, determining drug and dosing based on the characteristic, and administering the determined drug and dosing to the patient.

The ABM system may also be used to predict the characteristic of the state of the biological system even though the actual state is not observed, For example, the biological system may be erythropoiesis of a patient, the characteristic may be the red blood cell count, and the parameters of the physiological model may include the rate of red blood cell production and the rate of change in oxygen level. The ABM system can be used to predict the red blood cell count, A treatment plan for the patient may be based on the prediction of red blood cell count, rather than on an inference of the state based on red blood cell count. The red blood cell count can also be used to infer other characteristics such as the age distribution of red blood cell precursors and the concentration of erythropoietin.

The ABM system starts with an initial estimate of the state, the parameters, and the PDF. When a measurement of the state of the biological system is taken at a measurement time from a patient, the ABM system generates a new PDF based on the measurement and the physiological model. To generate the new PDF, the ABM system first generates an advected PDF by evolving the initial PDF (i.e., a prior PDF) to the measurement time by solving the advection PDE based on the physiological model of the biological stem The ABM system then generates a posterior PDF (i.e., the new PDF) by performing a learning process (e.g., Bayesian learning) that also generates new values for the parameters based on the advected PDF, the physiological model, and the measurement. Because new values for the parameters are generated, the physiological model is, updated based both on the measurements of the patient and on the advected PDF. Over time, the physiological model and the PDF can more accurately represent the physiology of the biological system of an individual patient.

The ABM system can use the new PDF to make predictions of the state of the biological system at various times in the future. To make predictions, the ABM system evolves the new PDF to a prediction time by solving the advection PDE based on the physiological model of the biological system. The predictions are made based on the evolved new PDF and the physiological model of the biological system

The ABM system may iterate the process of evolving the PDF using advection and learning to generate new PDF for each subsequent measurement taken at a measurement time. During the next iteration, the ABM system may use the previous posterior PDF of the previous iteration as the next prior PDF for the next iteration with the next measurement to generate a new posterior PDF for making predictions. The ABM system may also set the next prior PDF to a modified version of the previous posterior PDF that is stretched to reflect uncertainty or doubt in the accuracy of the previous posterior PDF.

The ABM system is described primarily in the context of a biological system, such as the liver or erythropoiesis, of an individual organism. However, the ABM system may be used to model a variety of activities of different systems. Such systems may include geological systems (e.g., flow of lava, melting of polar ice caps, or occurrence of an earthquake), social systems (e.g., interactions between members of a social, network and spread of information), environmental systems (e.g., growth of populations of animals and spread of toxic substances), financial systems (e.g., fluctuations in prices of securities and commodities), disease progression systems (e.g., spread of a disease in a individual or population), psychological systems (e.g., progress of a personality disorder), biological systems (e.g., heart, brain, liver, kidney, or gut tumor growth), and other physical and non-physical systems (e.g., dispersal of space debris). By providing an initial prior PDE, a model, and measurements for such system the ABM system may be use generate a posterior PDE for use in making predictions.

The ABM system is described primarily for the purple of predicting a future state of system. The ABM system may, however, be used for forensic purposes, that is, forming an estimate of what the state had been in the past. For example, if a population of people have died of a certain disease, the ABM system may be used to model the progression of that disease in each person based on the initial state of each person and measurements taken throughout the progression of the disease. The results may be used to identify more effective treatment regimes, to improve the model of how the disease progresses, and so on.

Because the ABM system factors in the measurements of the biological system of an individual organism, the ABM system evolves the PDF in a way that is tailored to that individual organism. For example, if the patient is being administered a drug that affects the production of red blood cells, the predictions using the PDF, which is evolved based on the measurements of the red blood cell counts taken while the patient is taking the drug, will reflect the effects of that drug over time. In particular, the teaming process will tend to evolve the parameters, such as rate of red blood cell production, to match that of the patient as indicated by the measurements. Thus, even if a parameter is initially set to a population-based value, it will evolve to match a value for the patient.

In some embodiments, during the time intervals between measurements, the ABM system continuously evolves the posterior PDF (i.e., generated based on the last measurement) using the advection PDE. When a measurement is taken, the ABM system suspends this continuous evolution. The ABM system uses the last posterior PDF as the prior PDF for the next iteration and generates the advected prior PDF. Because the learning process tends to narrow the posterior PDF, the confidence in the probabilistic understanding of the measurements and parameters increases. This narrowing, however, can slow the process of converging to true values and prevent the overall model from adapting to changes ire the underlying parameters of the biological system. To reduce the narrowing, the ABM system stretches the posterior PDF after each learning step and uses that stretched posterior PDF as the prior PDF for the next iteration. This stretching is considered to systematically add doubt to the probability density function. Because the ABM system adds doubt, the rate of convergence to new values for the parameters and the adaptability of the ABM system is improved.

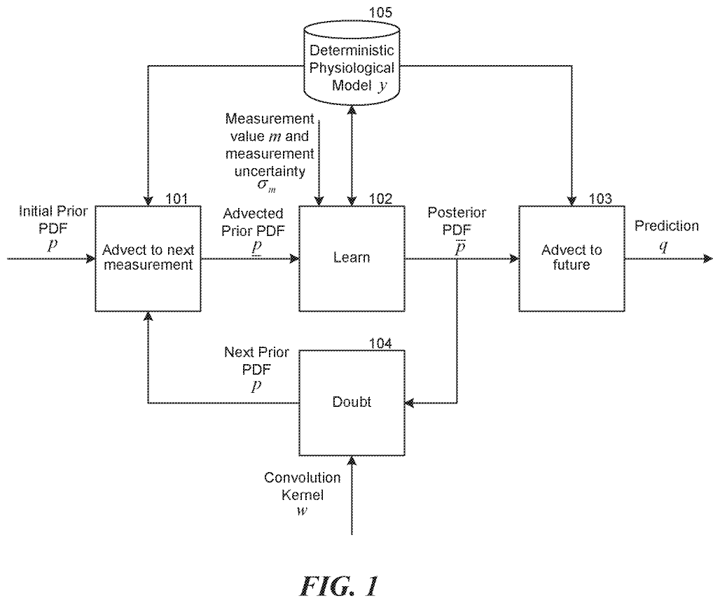

FIG. 1 is a block diagram that illustrates high-level components of the ABM system in some embodiments. When a measurement is received, an advect to next measurement component 101 accesses a deterministic physiological model y of data store 105 and receives an initial prior PDF p. The advect to next measurement component generates an advected prior PDF p by using the model y to advect the prior PDF p to the measurement time. For example, the deterministic physiological model y may be a model of a liver based on physiological dynamics, such as tumor size (i.e., state) and tumor growth rate (i.e., parameter). The initial prior PDF p may represent a measurement m of the tumor size at some prior time (e.g., measurement time of zero) based on a measurement uncertainty σₘ (e.g., based on accuracy of the measurement) and tumor growth rate (e.g., population-based). After each measurement, the advect to next measurement component inputs a next prior PDF p (i.e., the previous posterior PDF) and generates the next advected prior PDF p using the current parameters of the physiological model.

A learn component 102 inputs the advected prior PDF p and the current measurement m and a measurement uncertainty σₘ and applies a learning technique to learn new parameters and generate a posterior PDF p̅ based on the inputs. The learn component updates the parameters in the data store.

An advect to future component 103 inputs the posterior PDF p̅ and makes predictions q about the behavior of the biological system by advecting the posterior PDF p̅ to the prediction time by solving the advection PDE based on the physiological model of the biological system. This advected posterior PDF is then used to make predictions of the state of the biological system at the prediction time. For example, if a heath care provider wants a prediction of the tumor size of the patent one week after the last measurement, the posterior PDF p̅ is advected to a time of one week in the future (i.e., the prediction time) and that advected posterior PDF is used to make the prediction q of the tumor size.

A doubt component 104 inputs the posterior PDF p̅ and a convolution kernel w and generates a next prior PDF p. The doubt component stretches the posterior PDF p̅ to compensate for narrowing resulting from application of the learning technique. That stretched posterior PDF p̅ is then used as the next prior PDF p for the next iteration.

In some embodiments, the advect to next measurement component advects the prior PDF p, from the previous measurement time to the current measurement time, by solving the advection PDE, which can be represented by the following equation:

∂ₜp+∇_{y}·(pV)=0

V=\dot{y}

where ∂ₜp represents the partial derivative of the prior PDF p with respect to time t and ∇_{y}·(pV) is the divergence of pV, the product of p and V, where V is a vector field representing the deterministic physiological model y. The advection PDE preserves the volume of the functions that it evolves. Thus, the advection PDE evolves PDFs, not just density functions. The advection PDE can be solved In various ways, such as:

1. Finding the closed-form solution.

2. Solving via the method of characteristics.

3. Solving via an upwind differencing scheme (e.g., such as a weighted essentially non-oscillatory (“WENO”) scheme).

The time-varying PDF may be represented as p:T×Y→ [symbol] ⁺. For each time t, p(t,−):Y→ [symbol] ⁺ represents the PDF. The initial PDF is represented as p(t₀,−). The initial prior PDF p typically should not assign non-negative probabilities to physically impossible measurements and parameter values. As a result, lognormal PDFs may be preferable to normal PDFs.

A time-varying vector field is represented as V:T→y:Y→T_{y}Y, which defines the underlying physiological dynamics of the biological system. The vector field v defines the simultaneous evolution of both the state x and the time-varying parameters θ, represented as y=(x,θ). (The physiological model may also include parameters that are constant and thus not evolved.) The advect to next measurement component evolves the deterministic physiological model y assuming that the time-varying parameters are changing not via dynamics, just via learning updates, so that the time-varying parameters are piecewise constant in time. The deterministic physiological model y is the solution to a system of ordinary differential equations (“ODEs”) as represented by the following equation:

\dot{y}=V(t,y)

The ODEs can be solved using standard stiff ODE solving soft are such as SUNDIALS from Lawrence Livermore National Laboratory. (See A. C. Hindmarsh, P. N. Brown, K. E Grant, S. L. Lee, R. Serb an, D. E. Shumaker, and C. S. Woodward, SUNDIALS: Suite of Nonlinear and Differential/Algebraic Equation Solvers, ACM Transactions on Mathematical Software, 31(3), pp. 363-396, 2005, which is hereby incorporated by reference.)

In some embodiments, the learn component calculates the posterior PDF p̅ by applying Bayes' law to the advected prior PDF p using a likelihood function derived from the next measurement m and measurement uncertainty σₘ. The measurements are collected from the patient at scheduled times. The learn component uses a PDF ƒ(x;m,σₘ) for a univariate Gaussian random variable with a distribution of N(m,σₘ), or a similarly parameterized lognormal, to calculate the posterior PDF p̅. The formula for calculating the posterior PDF p̅ is represented by the following equation:

$$\overline{p} ( x , θ ) = \frac{\underline{p} ( x , θ ) \cdot f ( x ; m , {σ}_{m} )}{N}$$

$$N = {\int }_{X \times Θ} p ( x , θ ) \cdot f ( x ; m , {σ}_{m} ) dxd θ$$

In some embodiments, to calculate the prior PDF p, the doubt component adds doubt by “stretching” the posterior PDF p̅ through convolution with the convolution kernel w. The convolution of functions ƒ and g is represented by the equation:

(ƒ*g)(x)=∫ƒ(τ).g(x−τ)dτ

The integral may be multidimensional and can be calculated (1) using numerical routines or (2) in closed form of the functions ƒ and g that are particular PDFs. For example, if the functions are represented by the following equations:

ƒ˜N(μ_{ƒ},Σ_{ƒ})

g˜N(μ_{g},Σ_{g})

then the closed form may be represented by the following equation:

ƒ*g˜N(μ_{ƒ}+μ_{g},Σ_{ƒ}+Σ_{g})

As another example, if the functions are represented by the following equations:

ƒ˜exp(N(μ_{ƒ},Σ_{ƒ}))

g˜exp(N(μ_{g},Σ_{g}))

then the closed form may be represented by the following equation:

ƒ*g˜N(μ_{ƒ}+μ_{g},Σ_{ƒ}+Σ_{g})

with the constraints that E ƒ=E g where E ƒ=∫(x.ƒ(x))dx. The convolution kernel w is a PDF over stake x and the time-varying parameters θ that is, uncorrelated with the posterior PDF p̅. The convolution kernel w is thin with respect to state x and thin with respect to the time-varying parameters θ. The doubt component may use a convolution kernel w represented by the following equation:

w−N(μ,Σ)

where μ=0,

$$Σ = ( \begin{matrix}0 & 0 \\ 0 & ∈\end{matrix} ) ,$$

and ∈ is a small number. The next advected prior PDF p is represented by the following equation:

p=p̅*w,

In some embodiments, the advect to future component advects the posterior PDF p̅ to the measurement time using the advection PDE as represented by the following equations:

∂ₜp+∇_{y}.(pV)=0

V=\dot{y}

which are the same equations used by the advert to next measurement component.

The accuracy of the ABM system in predicting what an actual measurement will be can be demonstrated in various ways such as conducting a prospective, a retrospective, or clinical trial.

To conduct a prospective clinical trial, actual measurements are collected from a patient in real-time at collection times. The ABM system is used to personalize the parameter values of the ABM physiological model based on those actual measurements and then to evolve the PDF. The PDF is then used to generate predicted measurements for that patient at a prediction time in the future, At that prediction time, actual measurements are collected from the patient. When the predicted measurements accurately reflect (e.g., within an accuracy margin) the actual measurements at the predicted time, then the ABM system can be considered to be accurate.

To conduct a retrospective clinical trial, the actual measurements were collected from a patient at various collection times, including a prediction time, The ABM system is used to personalize the parameter values of the ABM physiological model based on those actual measurements with collection, times that are before the prediction time. The ABM system then evolves the PDF. The PDF then is used to generate predicted measurements for that patient at the predication time. When the predicted measurements accurately reflect (e.g., within an accuracy margin) the actual measurements previously collected at the prediction time, then the ABM system can be considered to be accurate.

To conduct a simulated clinical trial, simulated measurements are generated at various simulation times, including a prediction time, using an ancillary physiological model to simulate measurements. The simulated measurements can be considered to be measurements of a simulated patient. The ABM system is used to personalize the parameter values of the ABM physiological model based on those simulated measurements with simulated times that are before the prediction time. The ABM system then evolves the PDF. The ABM system is used to evolve a PDF based on the simulated measurements with simulation times that are before the prediction time. The PDF then is used to generate predicted measurements at the prediction time. When the predicted measurements accurately reflect (e.g., within an accuracy margin) the simulated measurements for the prediction time, then the ABM system can be considered to be accurate.

It the ancillary physiological model has the same form as the ABM physiological model used by the ABM system, the ancillary physiological model will have parameter values that will characterize the behavior of the simulated patient The ABM system is used to personalize the parameter values of the ABM physiological model based on those simulating measurements with simulated times that are before the prediction time. The ABM system then evolves the PDF. This personalizing and evolving is performed for various simulated times. If the parameter values for the ABM physiological model converge on the parameters for the ancillary physiological model, then the ABM system can be considered to be accurate. Thus, if the initial parameter values for the ABM physiological model are very different from those of ancillary physiological model, then accuracy of the ABM system is confirmed even when the initial parameter values for a patient are a poor guess of the actual parameter values for that patient.

Embodiments of the ABM system may be used as part of a method of beating a patient. To treat a patient, a care provider collects measurements of a characteristic of a state of a biological system of the patient. For example, the biological system may a liver, the state may be hepatocyte, and the characteristic may be liver enzyme count of the patient. The care provider then generates a prediction of a characteristic of a state of a biological system of the patient using a probability density function generated by the ABM system based on measurements of the characteristic collected from the patient and a physiological model of the biological system and based on advecting a prior PDF using the measurements and the physiological model. The care provider then infers from the prediction of the characteristic the state of the biological system. The care provider then determines course of treatment for the patient based on the inferred characteristic. The care provider then treats the patient accordance with the course of treatment. The course of treatment is based on a model predictive control system. The course of treatment may relate to dosing of a drug.

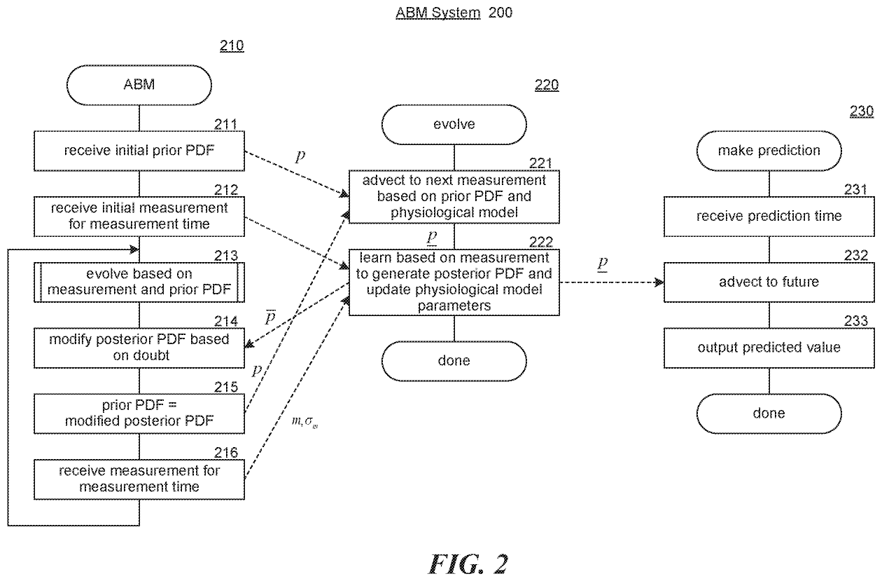

FIG. 2 includes flow diagrams that illustrate the overall processing of components of the ABM system in some embodiments. An ABM component 210 controls the overall processing of evolving PDFs based on advection, An evolve component 220 controls the evolving of a prior PDF to a posterior PDF based on a measurement. A make prediction component 230 makes predictions by evolving a posterior PDF based on advection. In block 211, the ABM component receives, an initial prior PDF for the initial state and time-varying parameters. In block 212, the ABM component receives an initial measurement representing the initial measurement time and a measurement uncertainty. In block 213, the ABM component invokes the evolve component to evolve the prior PDF based on the measurement, the current parameters of the physiological model, and the prior PDF to generate a posterior PDF, In block 214, the ABM component modifies the posterior PDF to factor in doubt in the learning of the parameters. In block 215, the ABM component sets the prior PDF to the modified posterior PDF. In block 216, the ABM component receives the next measurement and a measurement uncertainty for a measurement time. The ABM component then loops to block 213 to evolve the prior PDF based on the next measurement,

In block 221, the evolve component generates an advected prior PDF using the advection PDE. The directed dashed lines indicate data of the ABM component that is used by the evolve component. In block 222, the evolve component learns, based on the measurement, to generate a posterior PDF and completes. In block 231 the make prediction component receives a prediction time. In block 232, the make prediction component advects the posterior PDF to the prediction time. In block 233, the make prediction component outputs the predicted value based on the advected posterior PDF and then completes.

The computing devices and systems on which the ABM system may be implemented may include a central processing unit, input devices, output devices (e.g., display devices and speakers), storage devices (e.g., memory, and disk drives), network interfaces, graphics processing units, accelerometers, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing devices may elude desktop computers, laptops, tablets, e-readers, personal digital assistants, smartphones, gaming devices, servers, and computer systems such as massively parallel systems. The computing devices may, access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and include other storage means. The computer-readable storage media may have recorded upon or may be encoded with computer-executable instructions or logic that implements the ABM system. The data transmission media is used for transmitting data via transitory, propagating signals or carrier waves (e.g., electromagnetism) via a wired or wireless connection.

The ABM system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments. Aspects of the system may be implemented in hardware using for example, an application-specific integrated circuit (“ASIC”).

In the following, an example use of the ABM system is provided based on a model for the constrained growth of a tumor using simulated measurements,

In this example, the underlying physiology of the biological system is constrained exponential growth of the state which represents the size of a tumor. The ABM system will evolve the biological system from time t₀ to a future time. So the evolution of the system will be governed by an ODE as represented by the following equation:

$$\dot{x} = θ x ( 1 - \frac{x}{k} ) \qquad ( 1 )$$

where k is the ma Size of the tumor. This ODE has the following closed-form solution:

$$x ( t ; {t}_{0} , {x}_{0} ) = \frac{{kx}_{0} {e}^{θ ( t - {t}_{0} )}}{( k + {x}_{0} ( {e}^{θ ( t - {t}_{0} )} - 1 ) )} \qquad ( 2 )$$

where x₀ the value of the state at a time t₀. The value for the initial state x̆. The value for the growth rate is θ̆. So, the value state x is represented by the following equation:

$$x ( t ; {t}_{0} , \breve{x} ) = \frac{k \breve{x} {e}^{\breve{θ} ( t - {t}_{0} )}}{( k + \breve{x} ( {e}^{\breve{θ} ( t - {t}_{0} )} - 1 ) )} \qquad ( 3 )$$

This equation represents the ancillary model. These true values for the parameters are used only to produce simulated measurements.

The simulation of the ABM process starts with a prior PDF for x and θ, evolves x using equation (3) and uses measurements to update the PDF. The expectation of the marginal density for x will converge to x̆. The expectation for the marginal density for θ will converge to θ̆. The measurement at any time t will be random perturbations of the state taken from equation (3).

The initial condition will at time t₀ and the measurements will be taken at times represented as:

tᵢ,=1,2, . . . ,N. (4)

The time intervals between measurements are represented as

tᵢ=tᵢ₋₁+Δₜ,i=1,2, . . . ,N. (5)

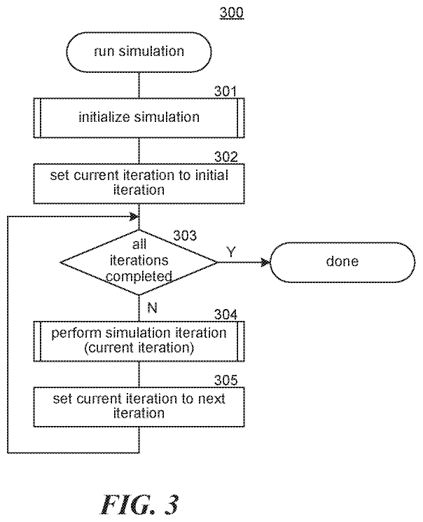

FIGS. 3-5 flow diagrams that illustrate the evolution of a PDF over time using simulated measurements. FIG. 3 is a flow diagram of a run simulation component. The run simulation component 300 controls the overall simulation. In block 301, the component invokes an initialize simulation component to establish the initial prior PDF and initial measurement. In block 302, the component sets the current iteration to the first iteration. In decision block 303, if all the iterations of the simulation have been completed, then the component completes, else the component continues at block 304. In block 304, the component invokes a perform simulation iteration component to perform the simulation for the current iteration. In block 305, the component sets the current iteration to the next iteration of the simulation and loops to block 303.

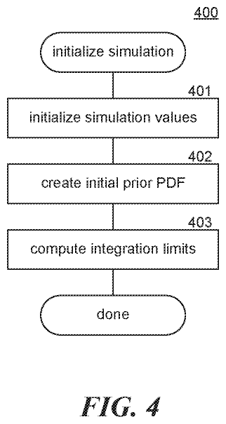

FIG. 4 is a flow diagram that illustrates the processing of an initialize simulation component. The initialize simulation component 400 generates initial simulation values and derives additional values from those initial values. In block 401, the component initializes the simulation values. In block 402, the component creates the initial prior PDF. In block 403, the component computes integration limits and then completes.

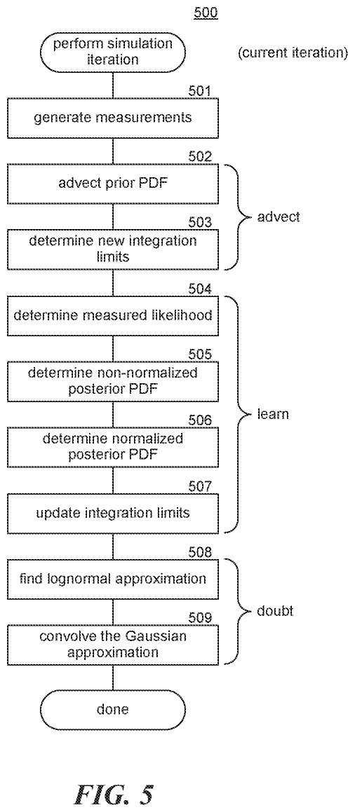

FIG. 5 is a flow diagram that illustrates the processing of a perform simulation iteration component. The perform simulation iteration component 500 performs the process for the current iteration. In block 501, the component generates the simulated measurements for the current iteration. In blocks 502-503, the component performs the advection to the next measurement. In block 502, the component advects the prior PDF to the advected prior PDF. In block 503, the component determines the new integration limits. Blocks 504-507 perform the learning to determine the parameter values and the posterior PDF. In block 504, the component determines the measured likelihood. In block 505, the component determines the non-normalized posterior PDF. In block 506, the component determines the normalized posterior PDF. in block 507, the component updates the integration limits. Blocks 508-509 correspond to the adjusting of the posterior PDF based on the doubt. In block 508, the component finds a lognormal approximation of the posterior PDF. In block 509, the component performs a convolution based on a Gaussian approximation and then completes.

Table 1 contains source code in the R programming language that implements the simulation.

```
TABLE 1
INITIALIZATION
Integrator
int2lim.vV <- function(h, lo, hi) {
  h.v <- function(x) {matrix(h(t(x)), ncol=ncol(x))}
  hcubature(h.v, lowerLimit <- lo, upperLimit <- hi, vectorInterface = TRUE)$integral }
Find first and second moments of any density.
E1V <- function(f, i, lo, hi) {
  int2lim.vV( {function(xx) {xx[,i]*f(xx)}}, lo, hi )}
  E2V <- function(f, i, j, lo, hi) {
  int2lim.vV( {function(xx) {xx[,i]*xx[,j]*f(xx)}}, lo, hi ) }
Find the parameters of a lognormal density from the moments of a given (not necessarily
lognormal) density.
InormParamsV <- function (g, n, lo, hi) {
  gcoefs <- list( )
  Ey <- vector(length=n)
  mu <- vector(length=n)
  Eyy <- matrix(0.,nrow=n, ncoj=n)
  sigma <- matrix(0.,nrow=n, ncol=n)
  cov <- matrix(0.,nrow=n, ncol=n)
  for (i in 1:n){
    Ey[i] <- E1V(g,i,lo, hi)}
  for (i in 1:n){
    for (j in 1:n){
      Eyy[i,j] <- E2V(g,i,j,lo,hi)
      sigma[i,j] <- log(Eyy[i,j]/(Ey[i]*Ey[j])) }}
  for (i in 1:n){
    mu[i] <- log(Ey[i]) − sigma[i,i]/2.}
  for (i in 1:n){
    for (j in 1:n){
      cov[i,j] <- Ey[i]*Ey[j]*(exp(sigma[i,j])−1.) }}
  gcoefs[[1]] <- mu
  gcoefs[[2]] <- sigma
  gcoefs[[3]] <- Ey
  gcoefs[[4]] <- cov
  gcoefs }
Convolve two bivariate Gaussian densities.
convGauss <- function( fcoefs, gcoefs ){
  hcoefs <- list( )
  hcoefs[[1]] <- fcoefs[[1]] + gcoefs[[1]]
  hcoefs[[2]] <- fcoefs[[2]] + gcoefs[[2]]
  hcoefs }
Compute a lognormal density value.
dmvlnorm <- function(y,mean,sigma) (1/apply(y,1,prod))*dmvnorm(log(y),mean,sigma)
Compute the parameters of a non-correlated lognormal density from its moments; e is a vector of
expected values and c is a vector of variances.
from.moments <- function(e,c){
  vone <- rep(1, length(e))
  D <- log(c/(e\hat{ }2) + vone)
  lcoefs <- list( )
  lcoefs[[1]] <- log(e) − D/2 #mu
  lcoefs[[2]] <- diag(D) #sigma
  lcoefs }
Find the mean (expectation) and the mode of a lognormal density.
emean <- function(mu,sigma)
  exp(mu + (1/2)*diag(sigma))
mode <- function(mu,sigma){
  vone <- rep(1., length(mu))
  c0 <- sigma %*% vone
  d0 <- mu-c0
  mode0 <- exp(d0) }
Dither a lognormal density with a normal density. Make sure that the mean (expectation) of the
dithered density is the same as the mode of the original density.
dithr.lognormal.fix.mean <- function(lognormal.coefs, gaussDithr.coefs){
  mu0 <- lognormal.coefs[[1]]
  dithrdcoefs <- convGauss(lognormal.coefs, gaussDithr.coefs)
  sigma1 <- dithrdcoefs[[2]]
  mu1 <- mu0 − (1/2)* diag(gaussDithr.coefs[[2]])
  function(y) dmvlnorm(y, mu1, sigma1) }
The functions that define constrained growth model.
# compute the growth in the forward direction
xf <- function(t,t0,x0,th,k) (k*x0*exp(th*(t−t0)))/(k + x0*(exp(th*(t−t0)) − 1.))
xfd <- function(delt,x0,th,k) (k*x0*exp(th*(delt)))/(k + x0*(exp(th*(delt)) − 1.))
# compute the growth in the reverse direction, i.e. look backwards
xpf <- function(delt,x1,th,k) (k*x1*exp(−th*delt))/(k + x1*(exp(−th*delt) − 1.))
# compute the spatial divergence piece of the solution to the advection equation
pplusf <- function(delt,xp,th,k) exp(−th*delt)*(1. +(xp/k)*(exp(th*delt) −1.))\hat{ }2
Specify the particular values for constants for this simulation.
set.seed(12345)
dithr.coeffs <- list( )
sigmam <- 0.
sigmalik <- 20.
delt = 0.25
kch <- 800.
x0<- .5
t0 <- 0.
thch <- 4.
nsig <- 5.
num.half <- 6
num.all <- 2 * num.half
Create the initial prior.
ee <- c(1,6) #expectation of the lognormal
cc <- .7*c(.5,1) #covariance of the lognormal
logcoefs <- from.moments(ee,cc)
mu <- logcoefs[[1]] #of the underlying normal
sig <- logcoefs[[2]] #of the underlying normal
mux <- mu[1]
sigmax <- sig[1]
muth <- mu[2]
sigmath <- sig[2]
#compute the initial integration limits
nn<-20
llo <- c(max(0.00001,ee[1]−nn*cc[1]), max(0.00001, ee[2]−nn*cc[2]))
hhi <- c(ee[1]+nn*cc[1], ee[2]+nn*cc[2])
#the initial prior. Named dithrd to enable looping
dithrd <- function (y) dmvinorm(y, mu, sig)
#compute the qualities for the initial prior
coeffsV <- lnormParamsV(dithrd,2,llo,hhi)
LOOP
for(i in 1:num.all){
  # Find the measured value
  x.hat.mean <- xfd(i*delt, x0, thch, kch)
  x.hat <- rnorm(n=1, mean=x.hat.mean, sd=sigmam)
  # Advect: Compute the advected prior
  # determine the new integraton limits by advection
  llo <- c(.1*xfd(delt, llo[1], thch, kch), llo[2])
  hhi <- c(xfd(delt, hhi[1], thch, kch), hhi[2])
  priV <- function(xx) {xp <-xpf(delt,xx[, 1],xx[,2],kch)
  dithrd(cbind(xp,xx[,2]))*pplusf(delt,xp,xx[,2],kch)}
  coeffsV <- lnormParamsV(priV,2,llo,hhi)
  Learn: Determine the measurement likelihood, then determine the non-normalized posterior
  lik <- function(x) dnorm(x, mean=x.hat, sd=sigmalik)
  nonnorm.postV <- function(xx) {priV(xx) * lik(xx[, 1])}
  #Learn: Detemine the normalized posterior
  v <- int2lim.vV(nonnorm.postV,llo,hhi)
  norm.postV <- function(xx) {(nonnorm.postV(xx))/v}
  norm.post.coeffsV <- lnormParamsV(norm.postV,2,llo,hhi)
  #update the integration limitee <- norm.post.coeffsV[[3]]
  ee <- norm.post.coeffsV[[3]]
  cc <- c(norm.post.coeffsV[[4]][1,1], norm.post.coeffsV[[4]][2,2])
  llo <- c(max(0.00001,ee[1]−nn*cc[1]), max(0.00001, ee[2]−nn*cc[2]))
  hhi <-c(min(ee[1]+nn*cc[1],kch), ee[2]+nn*cc[2])
#Doubt: Use moments to find the lognormal approximation to the normalized posterior.
  norm.post.gaussV0 <- function(xx) dmvlnorm(xx, mean=norm.post.coeffsV[[1]],
  sigma=norm.post.coeffsV[[2]])
  vnorm0 <- int2lim.vV(norm.post.gaussV0,llo,hhi)
  norm.post.gaussV <- function(xx) norm.post.gaussV0(xx)/vnorm0 #adjust for possible truncation at the
  right
  #Doubt: Convolve the Gaussian approximation with a Gaussian dithering kernel. dithr.coeffs[[1]] <-
  c(0,0)
  dithr.coeffs[[2]] <- matrix(c(0,0,0,.009),ncol=2,nrow=2)
  dithrd0 <- dithr.lognormal.fix.mean(norm.post.coeffsV, dithr.coeffs)
  vdithrd0 <- int2lim.vV(dithrd0,llo,hhi)
  dithrd <- function (xx) dithrd0(xx)/vdithrd0 #adjust for possible truncation at the right end of the vector
  coeffsV <- lnormParamsV(dithrd,2,llo,hhi)
}
```

The following paragraphs describe various embodiments of aspects of the ABM system and other systems. An implementation of the s esters may employ any combination of the embodiments and aspects of the embodiments. The processing described below may be performed by a computing system with a processor that executes computer-executable instructions stored on a computer-readable storage medium that implements the system.

In some embodiments, a method performed by a computing system for use in determining a characteristic of a state of a system is provided. The method accesses a prior probability density function (“PDF”) representing an initial characteristic and parameters of a model of the system. The method accesses a measurement of the state of the system at a measurement time. The method generates an advected prior PDF by advecting a prior PDF to the measurement time by solving an advection equation based on the system model and the prior PDF. The method generates a posterior PDF using a learn ng technique to learn new values of the parameters based on the advected prior PDF, the system model, the measurement and a measurement uncertainty. The posterior PDF is for determining the characteristic of the state of the system given the initial characteristic. In some embodiments, the method further comprises determining the characteristic for a later time after the measurement time by advecting the posterior PDF to the later time by solving an advection equation based on the system model and the posterior PDF. In some embodiments the method further comprises adjusting the posterior PDF to compensate for use of the learning technique wherein the adjusted posterior PDF is used as a next prior PDF when generating a next advected prior PDF. In some embodiments, the determined characteristic is a prediction of state of the system at a future time. In some embodiments, the determined characteristic is an estimate of the characteristic of the state of the system at a past time. In some embodiments, the determining of the characteristic is performed multiple times after the measurement time. In some embodiments, the method further comprises adjusting the posterior PDF to compensate for use of the learning technique wherein the adjusted posterior PDF is used as a next prior PDF when generating a next advected prior PDF, In some embodiments, the method further comprises, for each of a plurality of next measurement times setting a next prior PDF based on a previous posterior PDF of a previous measurement time; accessing a next measurement of the state of the system at the next measurement time; generating advected prior PDF by advecting the next prior PDF to the next measurement time by solving an advection equation based on the system model and the prior PDF; and generating a posterior PDF using a learning technique to learn new values of the parameters based on the advected prior PDF, the system model, the next measurement, and a measurement uncertainty. In some embodiments, the next prior PDF is set to a previous posterior PDF that has been modified based on uncertainty in the previous posterior PDF. In some embodiments, the learning technique is Bayesian learning, In some embodiments, the system is selected from a group consisting of geological systems, social systems, environmental systems, financial systems, disease progression systems, psychological systems, and biological systems.

In some embodiments, a method performed by a computing system for determining a next characteristic of a state of a system is provided. The method accesses a posterior probability density function (“PDF”) generated by advecting a prior PDF to a measurement time to generate an advected prior PDF by solving an advection equation based on a model of the system and learning values for parameters of the model based on the advected prior PDF, the model, a measurement of the system, and a measurement uncertainty. The method generates the next characteristic by advecting the posterior PDF to a next time that is later than the measurement time by solving an advection equation based on the model and the posterior PDF. In some embodiments, the system is a biological system. In some embodiments, the system is selected from a group consisting of geological systems, social systems environmental systems, financial systems, disease progression systems, psychological systems, and biological systems.

In some embodiments, a computing system for generating a probability density function (“PDF”) for determining a characteristic of a state of a system is provided. The computing system comprises one or more computer-readable storage mediums for storing computer-executable instructions and one or more processors for executing the computer-readable instructions stored in the one or more computer-readable storage mediums. The instructions control the computing system to generate an advected prior PDF by advecting a prior PDF to a measurement time of a measurement using a system model of the system, the system model having parameters, the prior PDF representing an initial time. The instructions control the computing system to generate a posterior PDF using a learning technique to learn new values of the parameters based on the advected prior PDF, the system model, and the measurement, wherein the posterior PDF is for determining the characteristic of the state of the system at a later time that is later than the measurement time. In some embodiments, the learning of the new values is further based on a measurement uncertainty. In some embodiments, the computer-executable instructions include instructions to determine the characteristic of the state at the later time by advecting the posterior PDF to the later time by solving an advection equation based on the system model and the posterior PDF. In some embodiments, the computer-executable instructions include instructions to adjust the posterior PDF to compensate for use of the learning technique wherein the adjusted posterior PDF is used as a next prior PDF when generating a next advected prior PDF. In some embodiments, the later time is a future time. In some embodiments, the later time is a past time. In some embodiments, the determining of a determined state is performed for multiple later times after the measurement time. In some embodiments, the computer-executable instructions include instructions to adjust the posterior PDF to compensate for use of the learning technique wherein the adjusted posterior PDF is used as a next prior PDF when generating a next advected prior PDF. In some embodiments, the computer-executable instructions include instructions to, for each of a plurality of next measurement times set a next prior PDF based on a previous posterior PDF of a previous measurement time; access a next measurement of the characteristic of the state of the system at the next measurement time; generate an advected prior PDF by advecting the next prior PDF to the next measurement time by solving an advection equation based on the system model and the prior PDF; and generate a posterior PDF using a learning technique to learn new values of the parameters based on the advected prior PDF, the system model, and the next measurement. In some embodiments, the next prior PDF is set to a previous posterior PDF that has been modified based on uncertainty in the previous posterior PDF. In some embodiments, the learning technique is Bayesian learning. In some embodiments, the system is selected from a group consisting of geological systems, social systems, environmental systems, financial systems disease progression system psychological systems, biological systems, and other systems.

In some embodiments, a method of treating a patient is provided. The method generates a prediction of a characteristic of a state of a biological system of the patient using a probability density function generated based on measurements of the characteristic and a physiological model of the biological system and based on advecting a prior PDF using the measurements and the physiological model. The method infers from the prediction of the characteristic the state of the biological system, the methods a course of treatment for the patient based on the inferred characteristic. The method treats the patient accordance with the course of treatment. In some embodiments, the course of treatment is based on a model predictive control system. In some embodiments, the course of treatment relates to dosing of a drug.

In some embodiments, a method of treating a patient provided. The method generates a prediction of characteristic of a state of a biological system using a probability density function (“PDF”) generated based on measurements of the characteristic and a physiological model of the biological system and based on advecting a prior PDF using the measurements and the physiological model. The method determines a course of treatment for the patient based on the prediction of the characteristic. The method treats the patient in accordance with the course of treatment.

From the foregoing, it will be appreciated that specific embodiments of the invention have been described herein for purposes of illustration, but that various modifications may be made without deviating from the scope of the invention. For example, the ABM system may be used to predict characteristics for both humans and non-humans. Accordingly, the invention is not limited except as by the appended claims.

1. A method performed by a computing system for use in determining a characteristic of a state of a system, the method comprising:
accessing a prior probability density function (“PDF”) representing an initial characteristic and parameters of a system model of the system;
accessing a measurement of the state of the system at a measurement time;
generating an advected prior PDF by advecting a prior PDF to the measurement time by solving an advection equation based on the system model and the prior PDF; and
generating a posterior PDF using a learning technique to learn new values of the parameters based on the advected prior PDF, the system model, the measurement, and a measurement uncertainty,
wherein the posterior PDF is for determining the characteristic of the state of the system given the initial characteristic.

2. The method of claim 1 further comprising determining the characteristic for a later time after the measurement time by advecting the posterior PDF to the later time by solving an advection equation based on the system model and the posterior PDF.

3. The method of claim 2 further comprising adjusting the posterior PDF to compensate for use of the learning technique wherein the adjusted posterior PDF is used as a next prior PDF when generating a next advected prior PDF.

4. The method of claim 2 wherein the determined characteristic is a prediction of state of the system at a future time.

5. The method of claim 2 wherein the determined characteristic is an estimate of the characteristic of the state of the system at a past time.

6. The method of claim 2 wherein the determining of the characteristic is performed multiple times after the measurement time.

7. The method of claim 1 further comprising adjusting the posterior PDF to compensate for use of the learning technique wherein the adjusted posterior PDF is used as a next prior PDF when generating a next advected prior PDF.

8. The method of claim 1 further comprising, for each of a plurality of next measurement times:
setting a next prior PDF based on a previous posterior PDF of a previous measurement time;
accessing a next measurement of the state of the system at the next measurement time;
generating an advected prior PDF by advecting the next prior PDF to the next measurement time by solving an advection equation based on the system model and the prior PDF; and
generating a posterior PDF using a learning technique to learn new values of the parameters based on the advected prior PDF, the system model, the next measurement, and a measurement uncertainty.

9. The method of claim 8 wherein the next prior PDF is set to a previous posterior PDF that has been modified based on uncertainty in the previous posterior PDF.

10. The method of claim 1 wherein the learning technique is Bayesian learning.

11. The method of claim 1 wherein the system is selected from a group consisting of geological systems, social systems, environmental systems, financial systems, disease progression systems, psychological systems, and biological systems.

12. A method performed by a computing system o determining a next characteristic of a state of a system, the method comprising:
accessing a posterior probability density function (“PDF”) generated by advecting a prior PDF to a measurement time to generate an advected prior PDF by solving an advection equation based on a model of the system and learning values for parameters of the model based on the advected prior PDF, the model, a measurement of the system, and a measurement uncertainty; and
generating the next characteristic by advecting the posterior PDF to a next time that is later than the measurement time by solving an advection equation based on the model and the posterior PDF.

13. The method of claim 12 wherein the system is a biological system.

14. The method of claim 12 wherein the system is selected from a group consisting of geological systems, social systems, environmental systems, financial systems, disease progression systems, psychological systems, and biological systems.

15. A computing system for generating a probability density function (“PDF”) for determining a characteristic of a state of a system, the computing system comprising:
one or more computer-readable storage mediums for storing computer-executable instructions for controlling the computing system to:
generate an advected prior PDF by advecting a prior PDF to a measurement time of a measurement using a system model of the system, the system model having parameters, the prior PDF representing an initial time; and
generate a posterior PDF using a learning technique to learn new values of the parameters based on the advected prior PDF, the system model, and the measurement, wherein the posterior PDF is for determining the characteristic of the state of the system at a later time that is later than the measurement time; and
one or more processors for executing the computer-readable instructions stored in the one or more computer-readable storage mediums.

16. The computing system of claim 15 wherein the learning of the new values is further based on a measurement uncertainty.

17. The computing system of claim 15 wherein the computer-executable instructions include instructions to determine the characteristic of the state at the later time by advecting the posterior PDF to the later time by solving an advection equation based on the system model and the posterior PDF.

18. The computing system of claim 15 wherein the computer-executable instructions include instructions to adjust the posterior PDF to compensate for use of the learning technique wherein the adjusted posterior PDF is used as a next prior PDF when generating a next advected prior PDF.

19. The computing system of claim 17 wherein the later time is a future time.

20. The computing system of claim 17 wherein the later time is a past time.

21. The computing system of claim 17 wherein the determining of a determined state is performed for multiple later times after the measurement time.

22. The computing system of claim 15 wherein the computer-executable instructions include instructions to adjust the posterior PDF to compensate for use of the learning technique wherein the adjusted posterior PDF is used as a next prior PDF when generating a next advected prior PDF.

23. The computing system of claim 15 wherein the computer-executable instructions include instructions to, for each of a plurality of next measurement times:
set a next prior PDF based on a previous posterior PDF of a previous measurement time;
access a next measurement of the characteristic of the state of the system at the next measurement time;
generate an advected prior PDF by advecting the next prior PDF to the next measurement time by solving an advection equation based on the system model and the prior PDF; and
generate a posterior PDF using a learning technique to learn new values of the parameters based on the advected prior PDF, the system model, and the next measurement.

24. The computing system of claim 23 wherein the next prior PDF is set to a previous posterior PDF that has been modified based on uncertainty in the previous posterior PDF.

25. The computing system of claim 15 wherein the learning technique is Bayesian learning.

26. The computing system of claim 15 wherein the system is selected from a group consisting of geological systems, social systems, environmental systems, financial systems, disease progression systems, psychological systems, biological systems, and other systems.

27-29. (canceled)
